(19) United States
(12) Patent Application Publication
(10) Pub. No.: US 2015/0292480 A1
(43) Pub. Date: Oct. 15, 2015

(54) Twin directional turbine / alternator / generator for wind power generation

(71) Applicant: Prakash Prabhakar Pawar, Prune (IN)

(72) Inventor: Prakash Prabhakar Pawar, Prune (IN)

(21) Appl. No.: 13/806,648

(22) PCT Filed: Sep. 23, 2010
(86) PCT No.: PCT/IN2010/000643

§ 371 Date: May 27, 2013

(30) Foreign Application Priority Data
Jul. 2, 2010 (IN) 1930/MUM/2010

(51) Int. Cl. F03D 3/00; F03D 9/00; F03D 3/02

(52) U.S. Cl. CPC F03D 3/005; F03D 3/02; F03D 9/002

(57) ABSTRACT

A vertical axis wind turbine power system having a twin direction turbine/generator/alternator (with or without permanent magnets AJC, D/C machine) wherein the rotor and stator (which may be different types including flange/flywheel types) move in opposite directions such that, if the rotor moves clockwise, the stator moves anti-clockwise and vice versa in order to generate more energy despite lesser wind velocity. The invention includes a novel wind turbine having a vertical axis with a twin directional turbine and two sets of blades that rotate in opposite directions from each other. The invention is also applicable in horizontal axis windmills or tidal energy generators.

### FIELD OF THE INVENTION

The present invention relates to a novel wind turbine power system. More particularly, this invention pertains to a wind turbine power system having a twin directional turbine/generator/alternator (with or without permanent magnets A/C, D/C machine) wherein the rotor and stator (which may be of different types including but not limited to flange/flywheel types of rotor and stator) is moving in opposite direction such that, if rotor moves clock wise at the same time stator moves anti-clockwise and vice versa in order to generate more energy despite of lesser wind velocity.

### BACKGROUND OF THE INVENTION

With the depletion of hydrocarbon fuels and increasing emphasis on environmental impact, alternative sources of energy have been sought. One source of alternative electrical energy is wind machines. Such wind machines have a number of disadvantages.

Due to increase in the carbon emission in the environment, it has become necessary to opt for green energy which is now-a-days achieved through many ways like solar, wind, tidal, etc. In all these practices we can produce pollution free energy but there are some major drawbacks to them. One of them is that it is not economically viable. For e.g.: about 8 to 10 years are required to recover the cost of one windmill. In general the existing windmills produce about 30% energy of their installed capacity throughout the year (kw/h basis) however there is no consistency because of the fluctuation of the wind speed as per the geographical distribution. As shown in following power curves. Windmills are designed to produce energy at its full capacity with a wind velocity of about 50 kmph (approx). Wind is not constant anywhere in the world. In the entire year, the wind does not even flow at about 50 kmph [or more] speed for the span of about 15 to about 20% of the total time [total calculation] If wind velocity drops at 50% (25 kmph), then the turbine produces 1/5^{th} or 1/6^{th} energy of the installed capacity and that is why the turbine produces about 30% energy [kw/h annual basis] of their installed capacity, hence they are not commercially viable.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention relates to a novel wind turbine power system. More particularly, this invention pertains to a wind turbine power system having a twin directional turbine/generator/alternator (with or without permanent magnets A/C, D/C machine) wherein the rotor and stator (which may be of different types including but not limited to flange/flywheel types of rotor and stator) is moving in opposite direction such that, if rotor moves clock wise at the same time stator moves anti-clockwise and vice versa in order to generate more energy despite of lesser wind velocity.

The novel wind turbine having a vertical axis comprise of twin directional turbine and two sets of blades. And wherein the rotor and stator is moving in opposite direction such that, if rotor is moving clock wise, stator will move anti-clockwise and vice versa in order to generate more energy despite of lesser wind velocity.

The present invention provides a vertical axis wind turbine wherein there is plurality of sets of blades which has an arrangement of said system enables them to rotate the rotor and stator in opposite direction such that, if rotor is rotates clock wise, stator will rotates anti-clockwise and vice versa in order to generate more energy despite of lesser wind velocity.

The present invention utilizes the blades of existing design or new designs in this vertical axis wind turbine and the twin directional wind turbine can also be applicable in horizontal axis windmills or in tidal energy generators.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather, than restrictive.

FIG. 1 illustrates the schematic view of the arrangements of various parts of twin directional wind turbine/generator/alternator.

FIG. 2 illustrates the enlarged view of the arrangements of vertical pole wherein the twin directional wind turbine/generator/alternator are mounted with the blades.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As shown in figures the present invention is directed to a novel wind turbine power system. More particularly, this invention pertains to a wind turbine power system having a twin directional turbine/generator/alternator (with or without permanent magnets A/C, D/C machine) wherein the rotor and stator (which may be of different types including but not limited to flange/flywheel types of rotor and stator) is moving in opposite direction such that, if rotor moves clock wise at the same time stator moves anti-clockwise and vice versa in order to generate more energy despite of lesser wind velocity.

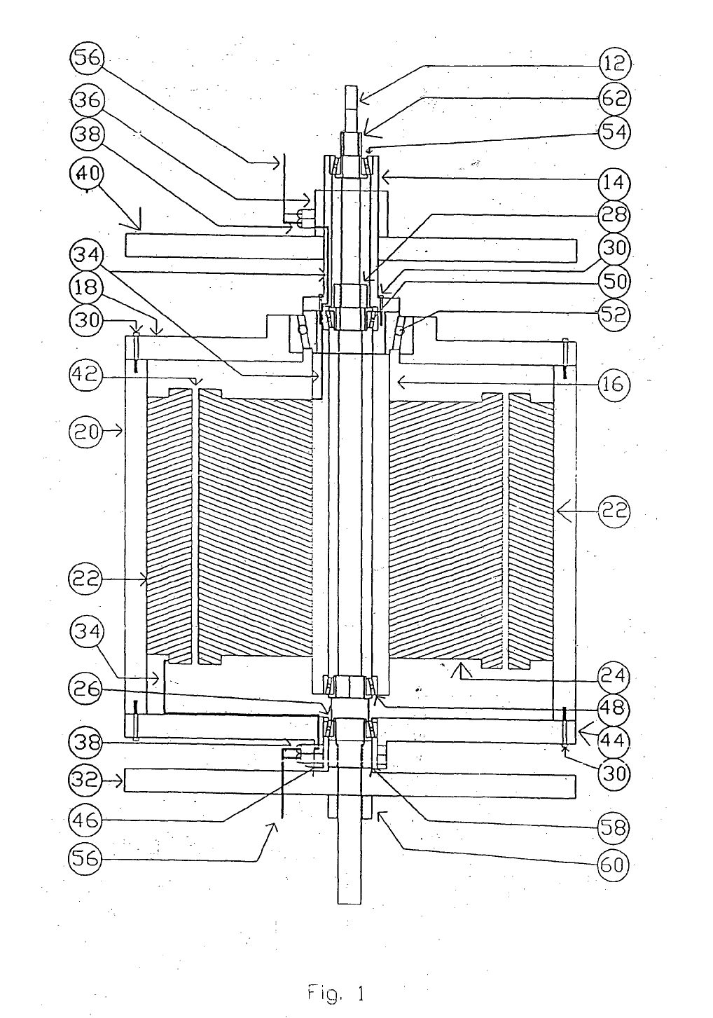

As shown in FIG. 1, there is provided a main static shaft (12) which is devoid of rotation and fixed by a nut (60) with the structure or base plate (32). Before fixing this static shaft (12) to the base plate (32), we have to fit bearing (26) on the static shaft (12), on this bearing (26) lower flange (44) of the stator body is mounted and bearing (26) is tightened by the nut (58), on the lower side of said flange (44), a commutator (46) and brush (38) is attached.

To this static shaft (12), there is one more bearing (48) on which the main hollow rotor shaft (16) is mounted vertically, followed by another bearing (50) which are mounted on the top of the same rotor shaft. Further a nut (28) is tightened to hold the bearing (50) on the main shaft (12).

The stator body (20) with the stators (22) is mounted on the lower flange (44) with the plurality of bolts (30). The upper flange of the stator body (18) is couples with the stator body with the bolts (30) and between this flange and the main hollow rotor shaft (16) there is one bearing (52) fixed.

The second hollow rotor shaft (14) holds bearing (52) and said shaft coupled with the main rotor shaft (16) with the plurality of bolts (30) there provided a fixed flange (40), a commutator (36), and brush (38) to the shaft (14). On the top of this shaft (14) one more bearing is fixed (54) by a nut (62).

In said vertical axis wind turbine, the previously mentioned twin directional generator/alternator/turbine (FIG. 1) is used. In said design, the turbine is fixed (70) on the vertical shaft (82) which is extended downwards and coupled between flange (32) and vertical pole (80), flange (84) is used for coupling said shaft (82) to flange (32). Further, one end of a set of blade (76) is fixed to stator body flange (44) and the other end of the same set is fixed to the vertical shaft (82) with the help of bearing (78). The setting of said blades is made such that they will rotate in the opposite direction to rotor blades. Further, static shaft (72) is extended upwards and coupled with main static shaft (12) with the help of flange (74). Further one end of other set of blade (66) is fixed to the rotor flange (40) and the other end is fixed to the shaft (72) which is extended upwards again with the help of bearing (64). The setting of said blades is made such that they will rotate in opposite direction to stator blades (76).

There will be a supporting structure (68) provided which will hold and give extra strength to the complete assembly of this wind turbine and arrow (86) and (88) which is shown in the drawing depicts the direction.

In a given arrangement if permanent magnet is used then there will be only one commutator in the said arrangement when the said arrangement is used as a vertical axis, the axial load action downwards is taken up by the thrust bearings, Radial loads can cause dynamic unbalance of rotor and thrust bearing alone can not take up the radial loads, hence an additional bearing which is also refer to as guide bearing is provided to said arrangement of turbine. More than one guide bearing is used as per the design and loads thereby number of bearings changed accordingly.

The said arrangement provided with a wiring harness (34) which connects to the rotor and commutator/stator and commutator. Another wiring harness (56) connects to the grid or direct use of energy of the said system. There air gap (42) is provided between the rotor (24) and the stator (22).

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

Description of the Legends used in FIGS. of the present Invention.
FIG: 1

| | |
|---|---|
| 12. | A Main Shaft which holds the Hollow Rotor Shaft and the Base |
| | Mounting Plate. |
| 14. | Hollow Rotor Shaft, which is connected to [coupled with] |
| | the Main Hollow Rotor Shaft, and which is out of the Stator Body. |
| 16. | Main Hollow Rotor Shaft. |
| 18. | Flange [lower], which is mounted on a bearing which holds |
| | the Stator Body. |
| 20. | Stator Body. |
| 22. | Stator. |
| 24. | Rotor. |
| 26. | Bearing [for lower flange of the stator body]. |
| 28. | Nut. |
| 30. | Bolt. |
| 32. | Base Plate. |
| 34. | Wiring Harness. |
| 36. | Commutator, which is mounted on Hollow Rotor Shaft [part 14], |
| 38. | Brushes. |
| 40. | Flange which is coupled with Hollow Rotor shaft [part14]. |
| 42. | Air Gap. |
| 44. | Flange [lower] which is mounted on a bearing which holds |
| | the Stator Body. |
| 46. | Commutator, which is mounted on Flange [lower]. (Part 44) |
| 48. | Bearing. [For the bottom side of the Main Hollow Shaft] |
| 50. | Bearing. [For the upper side of the Main Hollow Shaft] |
| 52. | Bearing. [Between the upper Flange (part 18) of the Stator |
| | Body and Main Hollow Shaft [part 16]of the Rotor. |
| 54. | Bearing. [For the upper side of the Hollow Shaft. (Part 14). |
| 56. | Wiring Harness which connects to the grid or direct use of energy. |
| 58. | Nut, which holds to bearing [part 26] |
| 60. | Nut which holds to Base Plate [part 32]. |
| 62. | Nut which holds bearing [part 54]. |

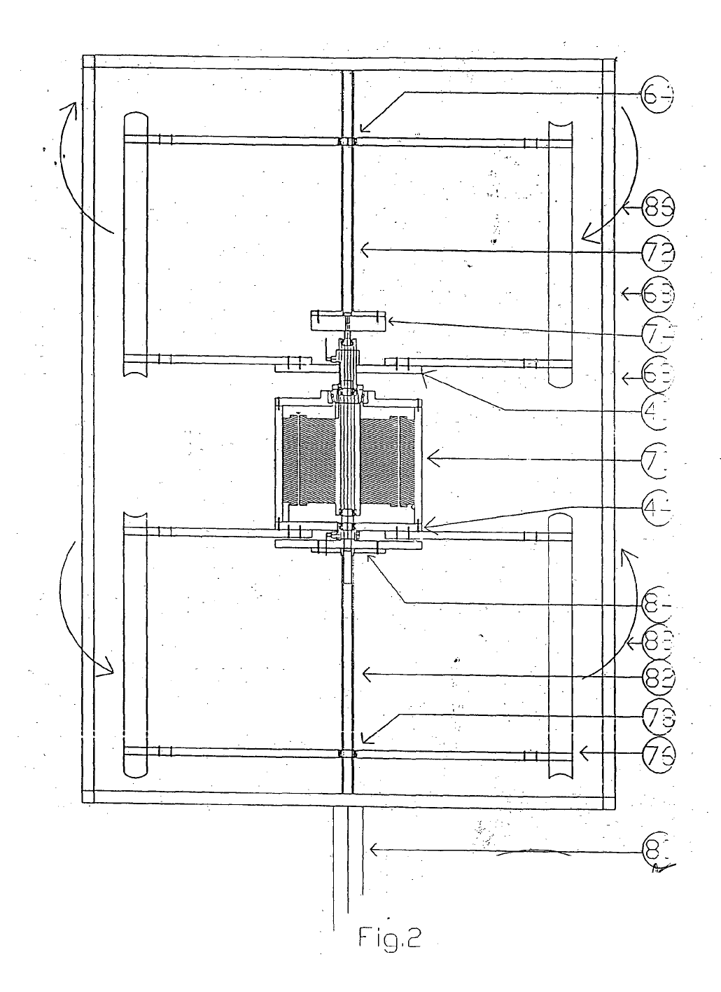

FIG. 2

| | |
|---|---|
| 64 | Bearing fixes other end of the blade to the shaft (72) |
| 66 | Outer set of Blades fixed to rotor flange (40) and bearing (64) |
| 68 | Supporting Structure |
| 70 | Twin directional turbine/generator/alternator |
| 72 | Shaft which is extended upwards and coupled with main shaft (12) |
| 74 | Flange for coupling shaft (72) and main shaft (12) |
| 76 | Blades fixed to stator body flange (44) and bearing (78) |
| 78 | Bearing fixes one end of the blade to vertical shaft (82) |
| 80 | Vertical Pole on which windmill is mounted |
| 82 | Shaft which is extended downwards and coupled with main shaft (12) |
| 84 | Flange for coupling shaft (82) and flange (32) |
| 86 | arrow which is showing rotor blades direction |

1. An improved wind power generation system comprising:
vertical axis shaft, mounting arrangement for twin directional turbine having two sets of bladed enabling the rotation in the opposite direction, plurality of rotatable blades, rotor, and stator, wherein rotor moves clock wise at the same time stator moves anti-clockwise and vice versa in order to generate more energy despite of lesser wind velocity.

2. An improved wind power generation system as claimed in claim 1, wherein the vertical axis shaft is fixed and not rotational.

3. An improved wind power generation system as claimed in claim 1, wherein turbine is with and without permanent magnet alternate current (AC) or direct current (DC) machine.

4. An improved wind power generation system as claimed in claim 1, wherein while rotor rotates in clock wise direction; simultaneously the stator rotates in anti-clock wise direction.

5. An improved wind power generation system as claimed in claim 1, wherein while rotor rotates in anti-clock wise direction simultaneously the stator rotates in the clock wise direction.

6. An improved wind power generation system as claimed in claim 1, wherein the twin directional turbine optionally is used in horizontal axis windmill or in tidal energy generators.

7. An improved wind power generation system as claimed in claim 1, wherein the rotor and the stator which may be of different types including but not limited to flange/flywheel types of rotor and the stator.
